(19) United States
(12) Patent Application Publication
(10) Pub. No.: US 2005/0044909 A1
(43) Pub. Date: Mar. 3, 2005

(54) Knob cylinder with biometrical sensor

(76) Inventor: Volker Lange, Hamburg (DE)

Correspondence Address: SHERIDAN ROSS PC, 1560 BROADWAY, SUITE 1200, DENVER, CO, 80202, US

(21) Appl. No.: 10/651,513

(22) Filed: Aug. 28, 2003

(51) Int. Cl. E05B 49/00

(52) U.S. Cl. 70/278.1

(57) ABSTRACT

The invention concerns a knob cylinder with a cylinder housing on which at least one side a knob is pivotably mounted for operating a lock catch, and with an electronic control which upon access authorization operates electronic switch means or coupling means in order to enable and/or to create a rotating-connection between the knob and the lock catch. According to the invention it is provided that a biometric sensor which cooperates with the electronic control and scans a fingerprint to determine access rights is located on the knob.

The invention relates to a knob cylinder with a cylinder housing comprising at least on one side a knob pivotably mounted for operating a lock catch, and an electronic control which upon access authorization operates electronic switch means or a coupling means to enable and/or create a rotating-connection between the knob and the lock catch.

Such lock cylinders which may be operated from at least one side with a turning knob and not with a key are commonly known. Often, the knob is located at the inner side of a room and always has a rotating-connection with the lock catch, so that it is always possible to unlock it and leave the room. Provided, there is a knob on the access side, it is often connected with an electronic control which upon an authorization signal operates electronic switch means or a coupling. This enables and/or creates a rotating-connection between the knob and the lock catch, and an opening of the door is possible. Typically, an external sensor, e.g. a transponder system or a biometric sensor pad or keypad located next to the door generates the authorization signal.

All these solutions have in common that the sensor, the electronic control and the lock cylinder are separate assemblies requiring increased mounting space and effort for installation and wiring. In particular, a supplementary installation is often not possible without difficulty. Another disadvantage lies in the fact that such knob cylinders with external sensors often require two hands to operate, i.e. one hand to turn the knob and the other to operate the sensor. This is considered very complicated.

It is an object of the invention to design a knob cylinder as described above in such a way as to significantly facilitate its installation and operation.

The object is solved by the invention by locating a biometric sensor on the knob which sensor interacts with the electronic control and scans a fingerprint to determine access rights. This arrangement has the advantage that the fingerprint of that hand is scanned which is simultaneously turning the knob. Thus a one-handed operation is possible.

The biometric sensor could be located on the knob's lateral surface. It is also possible to place the biometric sensor on the knob's front surface. In both cases, the sensor may be placed such that it detects for example the thumb print. The thumb can easily be brought into contact with a sensor located either on the front or lateral surface. This enables a reliable identification of the print.

Furthermore, it is favorable if the biometric sensor is located in a depression, especially an ergonomically formed depression of the knob. With that it is achieved that the thumb or finger can occupy a defined position such that the scanning and identification process is more reliable.

According to a preferred embodiment of the invention it is moreover provided that at least a part of the electronic control is located in the knob. This has the advantage that all necessary assemblies are located on the lock cylinder. The lock cylinder thus forms an independent and separate unit that can easily be installed at a later date.

An off-the-line power supply of the electronic control and the sensor would be useful in this context. To reduce power consumption, the electronic control should be activated only when needed. To achieve this, the knob may be mounted axially to-and-fro movable. In the one end position, it operates a switch to activate the electronic control and, in the other end position, at least one spring keeps it non operated. With that, activation, subsequent operation and opening of the door can still be done with one hand.

Especially, in a door which is opened by pushing, the knob can operate the switch in the pushed-in position. In a door which is opened by pulling, the knob can operate the switch in the pulled-out position. In each case, this corresponds to the logical movement of the person operating it.

It may be useful to locate the electronic control on the side of the cylinder housing which is turned away from the access side. The biometric sensor may be signal connected to the electronic control by wire or wireless. As a whole, it is achieved that it is much more difficult to manipulate or destroy the electronic control from the outside.

The electronic control may be part of an access control system which monitors the closing and opening processes of the door in question and also of other doors. To achieve this, the electronic control may be connected to a control station by wire or wireless. It is also possible that a transmission unit is mounted near the door to send signals wireless to the electronic control or receive these from it. The transmission unit itself may be wired to a control station. This minimizes the power used for transmission and hence the electronic control's power consumption. As before, the knob cylinder lock remains completely independent of external assemblies.

In the following, the invention is explained in more detail with the help of the drawings. It shows:

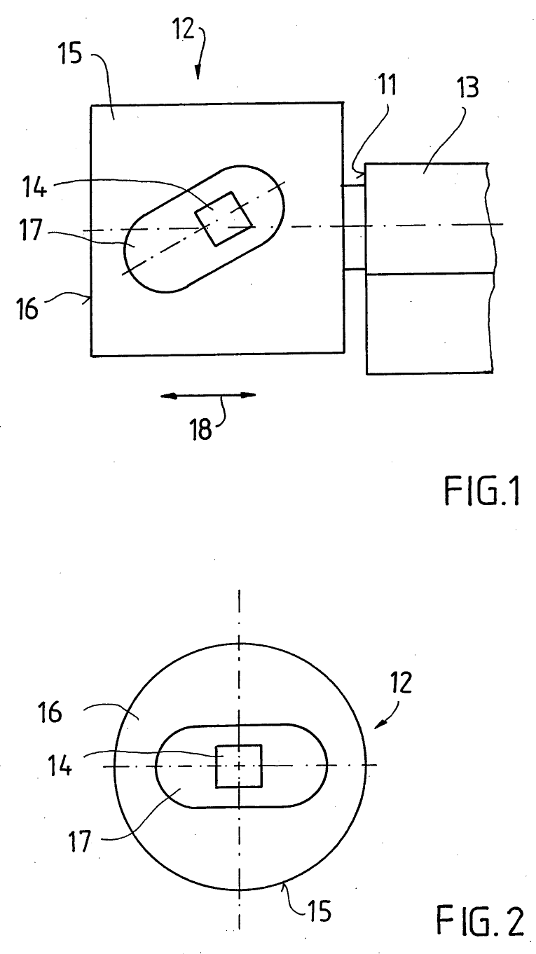

FIG. 1 a side view of a knob cylinder according to the invention and

FIG. 2 a frontal view of a knob cylinder according to the invention.

The knob cylinder shown in the drawing comprises on at least one face side 11 a knob 12 pivotably mounted in a cylinder housing 13. The cylinder can be either a profile cylinder or a round cylinder and may especially have standardized and/or normalized dimensions. The knob serves to operate a lock catch which operates a locking bar to unlock a door in the usual way.

In the knob 12 an electronic control (not shown) is provided which interacts with at least one biometric sensor 14. The biometric sensor is located on the knob 12 and detects a finger- or thumbprint. Once access is authorized based on matching prints, an authorization signal is generated by which an electronic switch means or electronic coupling switches, and a rotating-connection between the knob and the lock catch is generated or enabled.

As shown in FIG. 1, the biometric sensor may be located on the lateral surface 15 of the knob. However, alternatively or additionally, it may be provided that the sensor is located on the front surface 16 of the knob 12. In the example shown, the sensor 14 is located in a hollow 17 or depression on the knob. With that, it is achieved that the used finger or thumb can safely be guided to the sensor and be pressed on it. Furthermore, the finger is held in the hollow onto the sensor in such a way that an error-free scanning is possible. Preferably, the hollow should be formed ergonomically.

In principle one biometric sensor will be sufficient. Said hollow on the lateral surface may run parallel to the knob's axis of rotation. However, an angled extension of the hollow 17 may be provided depending on the most ergonomic grip position of the finger or thumb. If the hollow is asymmetrically arranged in such a way, it may be useful to provide two sensors in oppositely aligned hollows, in order to enable an easy operation by right- and left-handed persons.

Thus, the biometric sensor may be located eccentrically on the front surface in order to prove a good scanning position of the thumb or finger. But in principle, a centric arrangement may be provided as well.

The electronic control, the electrical switching means or coupling, as well as the biometric sensor are supplied with energy by an off-the-line power supply. Therefore, it is provided that the electronic system be activated only when needed. For this, the knob 12 is in axial direction 18 to-and-fro movably mounted in the cylinder housing 13. In the one end position, the electronic system is switched on and is activated, while in the other end position said knob is kept in the inoperative position by spring means. The activated state may be limited in time. It may also be provided that the electronic system only turns on for a predetermined period of time once the knob has been turned.

The cylinder housing may have standard dimensions and may be a profile cylinder or round cylinder. This makes such a knob cylinder quickly and easily mountable in conventional cases of a lock. Nevertheless, a high-quality electronic system and an accordingly secure access control can be achieved by the personal fingerprint.

Above and in the drawing, the knob cylinder is described only with a knob on the access side. On the other side of the knob cylinder a knob with sensor, a conventional knob always having a rotating-connection to the lock catch, or a conventional lock core can also be provided.

1. A knob cylinder having a cylinder housing on which at least one side a knob is pivotably mounted for operating a lock catch and having an electronic control adapted to enable a rotating-connection between the knob and the lock catch, characterized in that the knob cylinder comprises a biometric sensor, located on the knob and adapted to cooperate with the electronic control and to scan a fingerprint to determine access rights.

2. The knob cylinder according to claim 1, characterized in that the biometric sensor is located on the lateral surface of the knob.

3. The knob cylinder according to claim 1, characterized in that the biometric sensor is located on the front surface of the knob.

4. The knob cylinder according to claim 1, characterized in that the biometric sensor is located in a depression.

5. The knob cylinder according to claim 1, characterized in that the knob is axially to-and-fro movable mounted wherein, in the one end position, said knob is adapted to activate the electronic control and, in the other end position, said knob is adapted to be kept non operated.

6. The knob cylinder according to claim 5, characterized in that the knob is adapted to activate the electronic control in one of the pushed-in position and the pulled-out position.

7. The knob cylinder according to claim 1, characterized in that the knob is adapted to be axially to-and-fro movably mounted and to activate the electronic control in both end positions and to be non operated by at least one spring in the middle position.

8. The knob cylinder according to claim 4, characterized in that the electronic control is adapted to be activated by a switch upon a rotating movement of the knob.

9. The knob cylinder according to claim 1, characterized in that at least a part of the electronic control is located in the knob.

10. The knob cylinder according to claim 1, characterized in that the knob is located on a first side of the cylinder housing and the electronic control is located on a scond side of the cylinder housing.

11. A knob cylinder comprising:
a cylinder housing;
a knob pivotably mounted on a first side of the knob cylinder and adapted to operate a lock catch;
a first sensor positioned on the knob and adapted to scan at least a portion of at least one of a thumb and a finger; and
an electronic control electrically connected to the first sensor and adapted to receive a signal from the first sensor, to determine access rights and to enable a rotating connection between the knob and the lock catch.

12. The knob cylinder of claim 11, wherein the first sensor comprises a biometric sensor.

13. The knob cylinder of claim 11, wherein the first sensor is positioned on a lateral surface of the knob.

14. The knob cylinder of claim 11, wherein the first sensor is positioned on a front surface of the knob.

15. The knob cylinder of claim 11, wherein the knob comprises a first depression and at least a portion of the first sensor is positioned in the first depression.

16. The knob cylinder of claim 11, wherein the knob comprises a first depression shaped to substantially conform to at least a portion of at least one of a thumb and a finger and at least a portion of the first sensor is positioned in the first depression.

17. The knob cylinder of claim 11, further comprising:
a first depression in which at least a portion of the first sensor is positioned;
a second sensor positioned on the knob, adapted to scan at least a portion of at least one of a thumb and a finger and electrically connected to the electronic control; and
a second depression in which at least a portion of the second sensor is positioned.

18. The knob cylinder of claim 11, further comprising a second sensor positioned on the knob opposite the first sensor, the second sensor adapted to scan at least a portion of at least one of a thumb and a finger and electrically connected to the electronic control.

19. The knob cylinder of claim 11, wherein the electronic control is located within at least one of the knob and the cylinder housing.

20. The knob cylinder of claim 11, wherein the electronic control is located on a second side of the knob cylinder.

21. The knob cylinder of claim 11, further comprising a power source electrically connected to the electronic control.

22. The knob cylinder of claim 11, wherein the electronic control is adapted to be activated by operation of the knob.

23. The knob cylinder of claim 11, wherein the knob further comprises a switch adapted to activate the electronic control by operation of the knob in a to-and-fro motion.

24. The knob cylinder of claim 11, further comprising a monitor adapted to receive an electrical signal from the electronic control and to record the operation of the lock cylinder.

25. An access control system, comprising:
at least one knob cylinder comprising
a cylinder housing;
a knob pivotably mounted on a first side of the knob cylinder and adapted to operate a lock catch;
a first sensor positioned on the knob and adapted to scan at least a portion of at least one of a thumb and a finger;
an electronic control electrically connected to the first sensor and adapted to receive a signal from the first sensor, to determine access rights and to enable a rotating connection between the knob and the lock catch; and
a control station adapted to receive an electrical signal from the at least one knob cylinder and to record the operation of the at least one knob cylinder.

26. The knob cylinder of claim 25, wherein the first sensor comprises a biometric sensor.

27. The knob cylinder of claim 25, wherein the first sensor is positioned on a lateral surface of the knob.

28. The knob cylinder of claim 25, wherein the first sensor is positioned on a front surface of the knob.

29. The knob cylinder of claim 25, wherein the knob comprises a first depression and at least a portion of the first sensor is positioned in the first depression.

30. The knob cylinder of claim 25, wherein the knob comprises a first depression shaped to substantially conform to at least a portion of at least one of a thumb and a finger and at least a portion of the first sensor is positioned in the first depression.

31. The knob cylinder of claim 25, further comprising:
a first depression in which at least a portion of the first sensor is positioned;
a second sensor positioned on the knob, adapted to scan at least a portion of at least one of a thumb and a finger and electrically connected to the electronic control; and
a second depression in which at least a portion of the second sensor is positioned.

32. The knob cylinder of claim 25, further comprising a second sensor positioned on the knob opposite the first sensor, the second sensor adapted to scan at least a portion of at least one of a thumb and a finger and electrically connected to the electronic control.

33. The knob cylinder of claim 25, wherein the electronic control is located within at least one of the knob and the cylinder housing.

34. The knob cylinder of claim 25, wherein the electronic control is located on a second side of the knob cylinder.

35. The knob cylinder of claim 25, further comprising a power source electrically connected to the electronic control.

36. The knob cylinder of claim 25, wherein the electronic control is adapted to be activated by operation of the knob.

37. The knob cylinder of claim 25, wherein the knob further comprises a switch adapted to activate the electronic control by operation of the knob in a to-and-fro motion.
